(19) United States
(12) Patent Application Publication
(10) Pub. No.: US 2018/0287105 A1
(43) Pub. Date: Oct. 4, 2018

(54) SECONDARY BATTERY

(71) Applicant: LG CHEM, LTD., Seoul (KR)

(72) Inventors: Gil Young LEE, Daejeon (KR); Do Gyun KIM, Daejeon (KR); Sang Suk JUNG, Daejeon (KR)

(73) Assignee: LG CHEM, LTD., Seoul (KR)

(21) Appl. No.: 15/942,694

(22) Filed: Apr. 2, 2018

(30) Foreign Application Priority Data
Apr. 3, 2017 (KR) 10-2017-0042953

(51) Int. Cl. H01M 2/04

(52) U.S. Cl. CPC H01M 2/046

(57) ABSTRACT

Disclosed is a secondary battery. According to the present invention, a charging/discharging pin is prevented from being separated from a top cap while the secondary is charged and discharged to improve safety during the charging/discharging of the secondary battery. According to an aspect of the present invention, the secondary battery includes a can accommodating an electrode assembly, a top cap provided on an upper portion of the can, and a groove defined in a surface of the top cap and having a shape that is recessed downward. When the top cap is viewed from an upper side, the groove has a closed curve shape.

### CROSS-REFERENCE TO RELATED APPLICATIONS

The present application claims the benefit of the priority of Korean Patent Application No. 10-2017-0042953, filed on Apr. 3, 2017, in the Korean Intellectual Property Office, the disclosure of which is incorporated herein by reference.

### BACKGROUND OF THE INVENTION

### Field of the Invention

The present invention relates to a secondary battery, and more particularly, to a secondary battery having a structure that is capable of preventing short circuit from occurring by a charging/discharging pin coming into contact with the secondary battery when the secondary battery is charged and discharged.

### Description of the Related Art

To continuously use a secondary battery that is repeatedly chargeable and dischargeable, it is necessary to receive (i.e., charge) electrical energy from the outside or release (i.e., discharge) electrical energy to the outside according to situations.

FIG. 1 is a side cross-sectional view illustrating an upper structure of a secondary battery according to the related art.

Referring to FIG. 1, a secondary battery 1 includes a can 10 provided in a main body of the secondary battery 1 and having an internal space and a top cap 20 sealing the internal space of the can 1.

According to the related art, the top cap 20 for charging the secondary battery 1 comes into contact with a charging/discharging pin P at an upper portion thereof. However, the top cap 20 generally has a flat top surface. Thus, the charging/discharging pin may be slid from the top cap 20 while the secondary battery is charged and discharged. The slid charging/discharging pin P is separated from the upper portion of the top cap 20 to come into contact with other constituents of the secondary battery 2, which have a polarity different from that of the tap cap 20, thereby causing short circuit. For example, the charging/discharging pin may be slid in an S direction as illustrated in FIG. 1. Thus, the charging/discharging pin may come into contact with a crimping part 21 having a negative polarity. In this case, an external short circuit may occur to be dangerous.

This causes various safety accidents during the charging and discharging of the secondary battery.

### SUMMARY OF THE INVENTION

An aspect of the present invention provides a secondary battery in which a charging/discharging pin is prevented from being separated from a top cap of the secondary battery during charging/discharging of the secondary battery to improve safety while the secondary battery is charged and discharged.

According to an aspect of the present invention, there is provided a secondary battery includes: a can accommodating an electrode assembly; a top cap provided on an upper portion of the can; and a groove defined in a surface of the top cap and having a shape that is recessed downward, wherein, when the top cap is viewed from an upper side, the groove has a closed curve shape.

The groove may have a shape resembling a circumference of the top cap.

A circumference of the top cap may have a circular shape, and when the top cap is viewed from the upper side, the groove may have a concentric shape with a circumference of the top cap.

The groove may have a width equal to or greater than that of a charging/discharging pin that is used when the secondary battery is charged and discharged.

The groove may have a shape corresponding to that of an end of a charging/discharging pin that is used when the secondary battery is charged and discharged.

When the top cap is viewed from a side, a surface of a central portion of the top cap may protrude upward from a surface of a circumferential portion of the top cap, and the groove may be provided in the surface of the central portion of the top cap.

The groove may be provided in plurality.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a side cross-sectional view illustrating an upper structure of a secondary battery according to the related art;

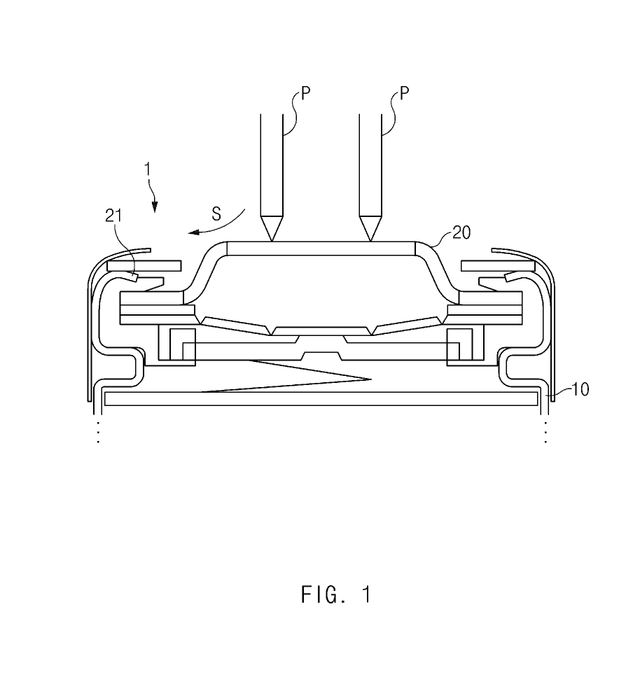

FIG. 2 is a side cross-sectional view of an upper structure of a secondary battery according to an embodiment of the present invention; and

FIG. 3 is a plan view illustrating the upper structure of the secondary battery according to an embodiment of the present invention.

### DETAILED DESCRIPTION OF THE PREFERRED EMBODIMENT

Hereinafter, a structure of a secondary battery according to the present invention will be described with reference to the accompanying drawings.

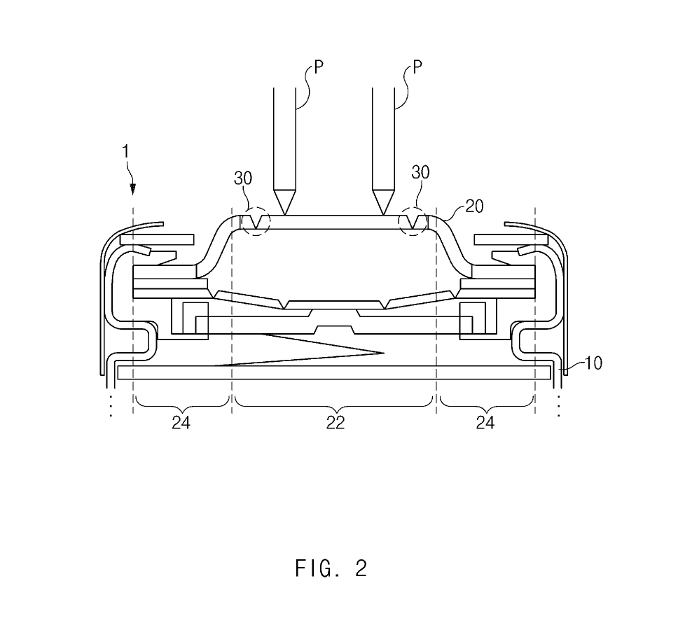

FIG. 2 is a side cross-sectional view of an upper structure of the secondary battery according to an embodiment of the present invention. The secondary battery 1 according to an embodiment of the present invention may be, for example, a cylindrical type secondary battery.

Referring to FIG. 2, the secondary battery 1 according to an embodiment of the present invention may include a can 10 providing a main body of the secondary battery 1 and having an internal space and a top cap 20 provided in an upper portion of the can 10 to seal the internal space of the can 10. An electrode assembly (not shown) may be provided in the internal space of the can 10. A circumference of the top cap 20 may have a circular shape, and the can 10 may have a cylindrical shape.

When viewed from the upper side, the top cap 20 may include a central portion 22 and a circumferential portion 24. Here, as illustrated in FIG. 2, when the top cap is viewed from the side, a surface of the central portion 22 of the top cap 20 may protrude upward from a surface of the circumferential portion 24. Also, each of the central portion 22 and the circumferential portion 24 of the top cap 20 may have a flat area.

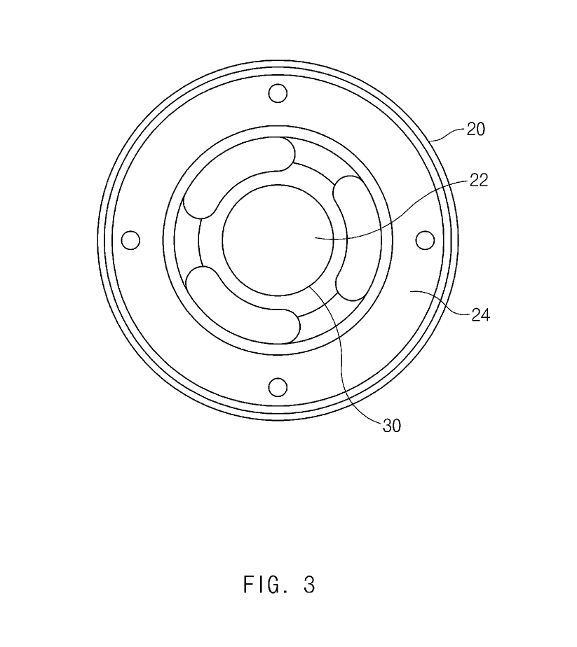

FIG. 3 is a plan view illustrating the upper structure of the secondary battery according to an embodiment of the present invention.

Referring to FIGS. 2 and 3, a groove 30 that is recessed downward may be defined in the surface of the top cap 20 of the secondary battery 1. Here, when the top cap 20 is viewed from the upper side, the groove 30 may have a closed curve shape. Here, while the secondary battery according to an embodiment of the present invention is charged and discharged, a closed curve may be defined so that a charging/discharging pin comes into contact with a surface, which is disposed inside the closed curve defined by the groove 30, of the surface of the top cap 20. For example, the groove 30 may be defined in a closed curve shape around a center of the top cap 20.

According to the related art, since the top cap has the flat top surface, the charging/discharging pin may be easy to be slid from the top cap while the secondary battery is charged and disclosed. If the slid charging/discharging pin is separated from the upper portion of the tap cap, the charging/discharging pin may come into contact with other constituents of the secondary battery, which have a polarity different from that of the top cap, to cause short circuit.

However, according to an embodiment of the present invention, since the groove that is recessed downward is defined in the surface of the top cap 20, the charging/discharging pin (see reference symbol P of FIG. 2) may be prevented from being separated from the top cap by being slid from the surface of the top cap 20. Particularly, when the groove 30 has the closed curve shape, the charging/discharging pin P may be effectively prevented from the top cap regardless of the direction in which the charging/discharging pin P is slid.

Continuing with reference to FIGS. 2 and 3, the groove 30 defined in the top cap 20 of the secondary battery 1 according to an embodiment of the present invention may have a shape resembling the circumference of the top cap 20. For example, when the circumference of the top cap 20 has a circular shape, the groove 30 may also have a circular shape. Particularly, when the circumference of the top cap 20 has the circular shape, the groove 30 may have a concentric shape with the circumference of the top cap 20.

As described above, the groove 30 of the secondary battery 1 according to an embodiment of the present invention may be a constituent for preventing the charging/discharging pin P from being slid. Here, to more effectively prevent the charging/discharging pin P from being separated from the upper portion of the tap cap 20, the groove 30 may have a width equal to or greater than that of the charging/discharging pin P that is used when the secondary battery 1 according to an embodiment of the present invention is charged and discharged. Particularly, the groove 30 may have a width greater than that of the charging/discharging pin P.

Similarly, to more effectively prevent the charging/discharging pin P from being separated from the upper portion of the top cap 20, the groove 30 may have a shape corresponding to that of the end of the charging/discharging pin P that is used when the secondary battery 1 is charged and discharged (alternatively, the groove 30 may have the same shape as the end of the charging/discharging pin P). In FIG. 2, the end of the charging/discharging pin P has a sharp shape, and thus, the groove 30 has a sharply recessed shape. When the groove 30 has a space corresponding to that of the end of the charging/discharging pin P, if the charging/discharging pin P is slid, the charging/discharging pin P may be engaged with the groove 30 to effectively prevent the charging/discharging pin P from being separated.

Unlike the embodiment of the present invention, the groove 30 according to the present invention may be provided in plurality. That is, a plurality of grooves may be provided in a top cap 20 of a secondary battery 1 according to another embodiment of the present invention. Since the plurality of grooves are provided in the top cap 20 of the secondary battery 1 according to another embodiment of the present invention, even though a portion of the plurality of grooves does not prevent a charging/discharging pin from being slid, the other portion of the plurality of grooves may prevent the charging/discharging pin from being slid. Therefore, the charging/discharging pin may be more stably prevented from being separated from an upper portion of the top cap.

Here, the plurality of grooves according to the present invention may be provided in a surface of a central portion.

In further another embodiment, a portion of the plurality of grooves may be defined in the surface of the central portion, and the other portion of the plurality of grooves may be defined in a surface of a circumferential portion of the top cap. For example, if two grooves are provided in the surface of the top cap, one groove may be provided in the surface of the central portion of the top cap, and the other groove may be provided in the surface of the circumferential portion of the top cap.

According to the present invention, the charging/discharging pin may be prevented from being separated from the top cap of the secondary battery during the charging/discharging of the secondary battery to improve the safety while the secondary battery is charged and discharged.

While the embodiments of the present invention have been described with reference to the specific embodiments, it will be apparent to those skilled in the art that various changes and modifications may be made without departing from the spirit and scope of the invention as defined in the following claims.

What is claimed is:

1. A secondary battery comprising:
a can accommodating an electrode assembly;
a top cap provided on an upper portion of the can; and
a groove defined in a surface of the top cap and having a shape that is recessed downward,
wherein, when the top cap is viewed from an upper side, the groove has a closed curve shape.

2. The secondary battery of claim 1, wherein the groove has a shape resembling a circumference of the top cap.

3. The secondary battery of claim 1, wherein a circumference of the top cap has a circular shape, and
when the top cap is viewed from the upper side, the groove has a concentric shape with a circumference of the top cap.

4. The secondary battery of claim 1, wherein the groove has a width equal to or greater than that of a charging/discharging pin that is used when the secondary battery is charged and discharged.

5. The secondary battery of claim 1, wherein the groove has a shape corresponding to that of an end of a charging/discharging pin that is used when the secondary battery is charged and discharged.

6. The secondary battery of claim 1, wherein, when the top cap is viewed from a side, a surface of a central portion of the top cap protrudes upward from a surface of a circumferential portion of the top cap, and
the groove is provided in the surface of the central portion of the top cap.

7. The secondary battery of claim 1, wherein the groove is provided in plurality.
